(19) United States
(12) Patent Application Publication
(10) Pub. No.: US 2025/0201936 A1
(43) Pub. Date: Jun. 19, 2025

(54) ELECTRODE FOR SECONDARY BATTERIES

(71) Applicant: Panasonic Energy Co., Ltd., Moriguchi-shi, Osaka (JP)

(72) Inventors: Koichi Sasai, Osaka (JP); Ryota Okimoto, Osaka (JP)

(73) Assignee: Panasonic Energy Co., Ltd., Moriguchi-shi, Osaka (JP)

(21) Appl. No.: 18/844,632

(22) PCT Filed: Mar. 10, 2023
(86) PCT No.: PCT/JP2023/009372

§ 371 Date: Sep. 6, 2024

(30) Foreign Application Priority Data
Mar. 17, 2022 (JP) 2022-042257

(51) Int. Cl. H01M 10/42; H01M 50/536

(52) U.S. Cl. CPC H01M 10/4235; H01M 50/536

(57) ABSTRACT

The electrode of a secondary battery comprises a mixture layer slant obtained by thinning a mixture layer around an exposed portion toward the exposed portion. The area of the mixture layer slant encompasses the area for adhering a protective tape that covers the exposed portion.

### TECHNICAL FIELD

The present disclosure relates to a structure of a lead attachment of an electrode for a secondary battery.

### BACKGROUND

Sealed non-aqueous electrolyte secondary batteries typified by lithium ion secondary batteries have a large energy density. In recent years, applications of non-aqueous electrolyte secondary batteries have been expanded to power tools, power-assisted bicycles, electric vehicles, and the like, and non-aqueous electrolyte secondary batteries are required to have high output and high output.

In many of the non-aqueous electrolyte secondary batteries, an electrode assembly in which a long positive electrode, a long negative electrode, and a long separator are wound in a vortex shape is used. In each electrode plate of the electrode assembly, a mixture layer is formed on a surface of the current collector. That is, in the case of the positive electrode, the mixture layer containing a positive electrode active material is formed on the surface of the positive electrode current collector, and in the case of the negative electrode, the mixture layer containing a negative electrode active material is formed on the surface of the current collector.

Here, the mixture layer is generally prepared by applying a paste-like mixture obtained by kneading and dispersing an active material (a positive electrode active material for a positive electrode, and a negative electrode active material for a negative electrode), a conductive agent, a binding agent (binder) and the like in a solvent to one surface or both surfaces of a current collector, drying the mixture, rolling the mixture to a predetermined thickness, and cutting the mixture into a predetermined shape.

In Patent Literature 1, one end side of an electrode lead is connected to an exposed portion obtained by partially removing a mixture layer of an electrode plate, and the other end side is connected to an electrode terminal of a battery. An insulating tape is attached to the electrode lead across the mixture layer so as to cover the exposed portion.

### CITATION LIST

### Patent Literature

PATENT LITERATURE 1: JP 2003-068271 A

### SUMMARY

Here, the mixture layer and the exposed portion have a step corresponding to the height of the mixture layer, and a protective tape thickness is added to an end of the mixture layer on the exposed portion side. Since the electrode plate expands and contracts due to a charge-discharge cycle, stress is concentrated at the end of the mixture layer and the end of the protective tape, so that the electrode plate may be cracked or deformed.

Meanwhile, it is conceivable to make the protective tape thin, but a foreign substance short-circuit resistance is lowered, and the risk that the protective tape is broken when the wound body is expanded in a charge-discharge cycle increases.

An electrode for a secondary battery according to the present disclosure includes: a belt-shaped core material; a mixture layer formed on a surface of the core material; and a lead that is bonded to an exposed portion of a surface of the core material, the exposed portion being exposed without the mixture layer being formed, and extends from one end side in a width direction of the core material, in which a mixture layer inclined portion inclined so that a thickness of the mixture layer around the exposed portion is reduced toward the exposed portion is provided, and a bonding margin of a protective tape covering the exposed portion falls within a range of the mixture layer inclined portion.

According to the present disclosure, in the secondary battery, since the step at the exposed portion-side end of the mixture layer and the protective tape end can be reduced, stress concentration at the step portion due to expansion and contraction of the electrode assembly can be reduced.

### BRIEF DESCRIPTION OF DRAWINGS

FIG. 1 is a cross-sectional view of an entire battery according to an embodiment.

FIG. 2 is a cross-sectional view illustrating a configuration of an electrode 50.

FIG. 3A is a schematic view illustrating a state where the electrode 50 is spread (before protective tape is attached) before winding.

FIG. 3B is a schematic view illustrating a state where the electrode 50 is spread (after protective tape is attached) before winding.

FIG. 4A is a cross-sectional view of a portion including an exposed portion 52a of the electrode 50.

FIG. 4B is a cross-sectional view (partially enlarged view) of a portion including the exposed portion 52a of the electrode 50.

### DESCRIPTION OF EMBODIMENTS

Hereinafter, embodiments of the present disclosure will be described with reference to the drawings. Note that the following embodiments do not limit the present disclosure, and a configuration obtained by selectively combining a plurality of examples is also included in the present disclosure.

### “Overall Configuration”

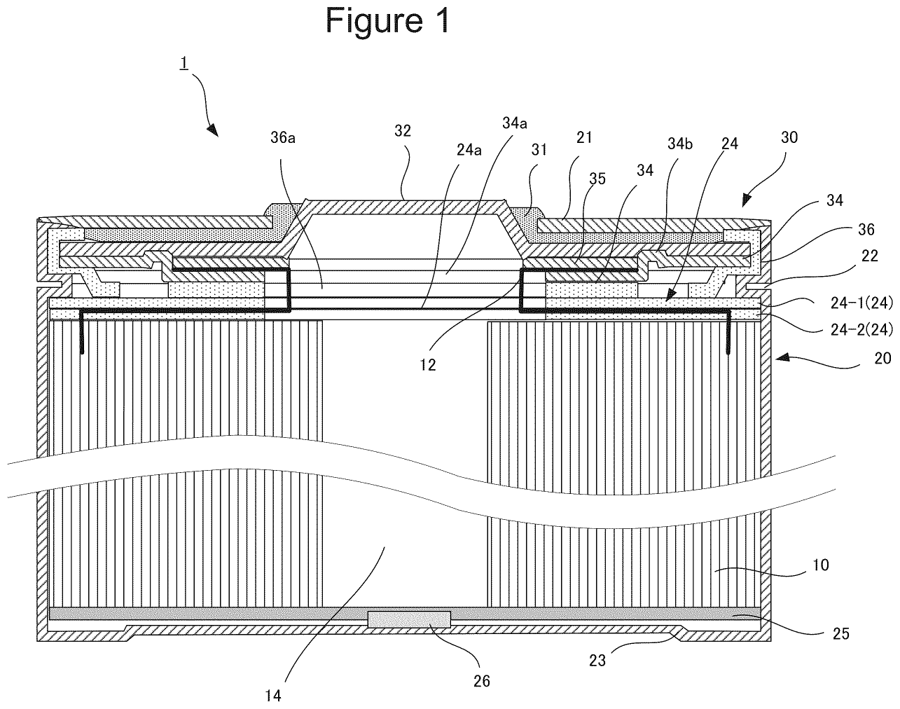

FIG. 1 is a cross-sectional view of a battery 1 as an example of a secondary battery according to an embodiment. In the present embodiment, a cylindrical battery is illustrated, but another shape such as a square shape may be used.

As illustrated in FIG. 1, a battery 1 includes a cylindrical electrode assembly 10, a cylindrical exterior can 20 in which an upper end for housing the electrode assembly is opened, and a circular sealing assembly 30 for closing an opening of the exterior can 20. An electrolytic solution is accommodated in the exterior can 20 together with the electrode assembly 10. The electrolytic solution may be an aqueous electrolytic solution, but in the present embodiment, a non-aqueous electrolytic solution is used.

The exterior can 20 has an annular groove portion 22 on an upper peripheral wall, and the sealing assembly 30 is supported by the groove portion 22 to close an opening of the exterior can 20. For convenience of description, the sealing assembly 30 side of the battery 1 is called as an upper side, and the bottom side of the exterior can 20 is called as a lower side.

The electrode assembly 10 is a winding-type electrode assembly in which a positive electrode and a negative electrode are wound with a separator interposed therebetween. In the present embodiment, a positive electrode lead 12 connected to the positive electrode extends upward from the outer peripheral side of the electrode assembly 10. A disk-shaped upper insulating plate 24 is disposed on the upper side of the electrode assembly 10. In this example, the upper insulating plate 24 is formed by overlapping two upper first insulating plates 24-1 and lower second insulating plates 24-2. The upper insulating plate 24 has an opening 24a in the central portion, and the positive electrode lead 12 extends upward from the outer portion of the electrode assembly 10, extends inward, and then extends upward through the opening 24a of the upper insulating plate 24.

The sealing assembly 30 includes a cap 32, a current collector plate 34, and a gasket 36, and is formed into a disk shape as a whole. An end on an outer peripheral side of the sealing assembly 30 is disposed on the groove portion 22 of the exterior can 20, and an upper end of the exterior can 20 is bent inward, whereby the sealing assembly 30 is caulked and fixed to an upper end of the exterior can 20 to close the opening of the exterior can 20.

The cap 32 is a metal member that is circular as a whole and has a central portion protruding upward. A wiring member is connected to the cap 32 when the battery 1 is modularized to form a battery module, and functions as a positive electrode external terminal in the present embodiment.

An upper portion of a raised portion of the cap 32 is exposed, but an insulating ring 31 is disposed on a ring-shaped flat portion outside the raised portion, and a ring-shaped negative electrode terminal 21 is disposed thereon. In this example, since the exterior can made of metal is connected to the negative electrode of the electrode assembly 10, a peripheral portion of the negative electrode terminal 21 is connected to the portion bent inward of the upper end of the exterior can 20. The negative electrode terminal 21 functions as a negative electrode external terminal of the battery 1.

The current collector plate 34 is a metal member having a diameter similar to that of the cap 32, and is disposed closer to the electrode assembly 10 than the cap 32. The current collector plate 34 has an opening 34a at a radial center. The cap 32 and the current collector plate 34 are welded, and the current collector plate 34 is welded, for example, at a position closer to the outer peripheral edge than the radial center of the cap 32. An annular projection 34b described later is formed on the current collector plate 34, and the projection 34b serves as a welded portion with the cap 32. A recess corresponding to the projection 34b of the current collector plate 34 is formed on the lower side of the cap 32.

An upper current collector plate 35 is disposed on an upper side of current collector plate 34 and on an inner side of the projection 34b so as to overlap current collector plate 34. Then, the positive electrode lead 12 that has passed through the inside of the upper insulating plate 24 is inserted and connected between the upper current collector plate 35 and the current collector plate 34. An opening is also provided in a central portion of upper current collector plate 35.

The gasket 36 covers an outer peripheral portion of a laminate of the cap 32 and the current collector plate 34 from the upper side of the periphery of the cap 32, then extends inward along the lower surface of the current collector plate 34, and is interposed between the current collector plate 34 and the upper insulating plate 24. The gasket 36 is an annular resin member or rubber member for preventing the cap 32 and the current collector plate 34 from coming into contact with the exterior can 20 to ensure insulation between the exterior can 20 and the sealing assembly 30. The gasket 36 fills up a gap between the exterior can 20 and the sealing assembly 30 at the outer peripheral portion of the laminate to seal the inside of the battery 1.

An opening 36a vertically overlapping with the opening 34a of the current collector plate 34 and the opening 24a of the upper insulating plate 24 is formed at a radial center of the gasket 36, and the positive electrode lead 12 passes therethrough. In this example, a through hole 36b is formed in a portion of the gasket 36 located below the current collector plate 34.

The negative electrode of the electrode assembly 10 is connected to the negative electrode current collector plate 25 disposed below the negative electrode, and the negative electrode current collector plate 25 is connected to the exterior can 20 at a joint 26. As described above, the negative electrode terminal 21 is connected to the exterior can 20. A part of the negative electrode of the electrode assembly 10 may extend downward and be connected to the negative electrode current collector plate 25, but a negative electrode lead may be provided, and the negative electrode of the electrode assembly 10 and the negative electrode current collector plate 25 may be connected by the negative electrode lead.

A circular step 23 is provided at a bottom of the exterior can 20. The inside region of the step 23 functions as a safety valve that operates when an abnormality occurs in the battery 1. In the central portion of the electrode assembly 10, there is a hollow portion 14 corresponding to the inside space of the winding start.

### “Configuration of Electrode Assembly 10”

Each of the positive electrode, the negative electrode, and the separator of the electrode assembly 10 is a belt-shaped long body, and is configured by sandwiching the separator between the positive electrode and the negative electrode and spirally winding the separator.

### <Configuration of Electrode>

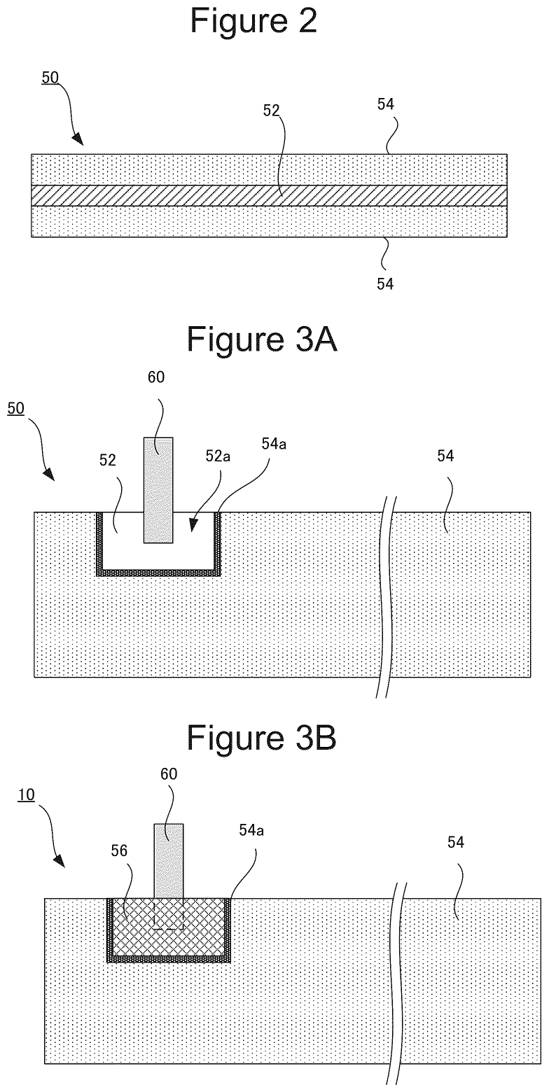

FIG. 2 is a cross-sectional view illustrating a configuration of an electrode 50 serving as the positive electrode or the negative electrode. In this manner, a mixture layer 54 is formed on both surfaces of a core material 52. The core material 52 is made of a conductive material such as a metal foil, and the mixture layer 54 is a layer containing a positive electrode active material in the case of a positive electrode and a negative electrode active material in the case of a negative electrode, and is formed by coating.

FIGS. 3A and 3B are schematic views illustrating a state in which the electrode 50 is spread before winding, in which FIG. 3A illustrates a state before the protective tape is attached, and FIG. 3B illustrates a state after the protective tape is attached.

As illustrated in FIG. 3A, the electrode 50 has a long belt shape as a whole, and an exposed portion 52a in which the mixture layer 54 is removed and the core material 52 is exposed is formed at an end in the width direction on one end side. A lead 60 is connected to the exposed portion 52a. When the electrode 50 is a positive electrode, the lead 60 is one end of the positive electrode lead 12 and is welded to the core material 52 of the exposed portion 52a.

When the lead 60 is welded to the core material 52 of the exposed portion 52a, as illustrated in FIG. 3B, the protective tape 56 covers the exposed portion 52a including the lead 60, and covers an end 54a of the mixture layer 54 on the exposed portion 52a side. The protective tape 56 has an adhesive layer, thereby covering the lead 60, the exposed portion 52a, and the end 54a.

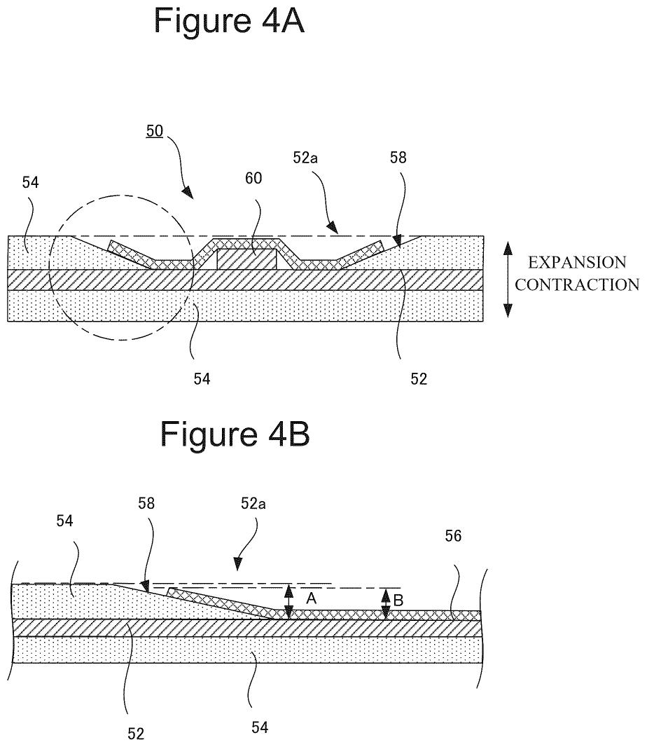

FIG. 4A is a cross-sectional view of a portion including exposed portion 52a of electrode 50, and FIG. 4B is a partially enlarged view. As described above, the end 54a around the exposed portion 52a of the mixture layer 54 is a mixture layer inclined portion 58 inclined toward the exposed portion 52a. Therefore, the protective tape 56 positioned on the mixture layer inclined portion 58 is not greatly bent at the boundary with the exposed portion 52a. Therefore, in this portion, it is possible to prevent a large load from being applied to the protective tape 56.

Further, an outer end of the protective tape 56 is terminated in the middle of the mixture layer inclined portion 58, a bonding margin of the protective tape 56 is accommodated in the mixture layer inclined portion 58, and a height of the outer end of the protective tape 56 in a thickness direction is lower than the height of the non-inclined portion on the outer side of the mixture layer inclined portion 58. Therefore, even when the protective tape 56 is wound, it is possible to prevent a large load from being applied to the end of the protective tape. That is, as illustrated in FIG. 4B, a height B of the protective tape 56 attached onto the mixture layer inclined portion 58 from the core material 52 is set to be equal to or less than a height A (A≥B) of the outer non-inclined portion from the core material 52. In this way, there is no step around the exposed portion 52a, and it is possible to prevent an excessive load from being applied to the protective tape 56.

### “Formation of Mixture Layer Inclined Portion 58”

As described above, the mixture layer inclined portion 58 is formed in the vicinity of the exposed portion 52a of the mixture layer 54 of the electrode 50. The mixture layer 54 is formed by spot intermittent coating, and the supply of the coating agent (composite) is stopped to form the exposed portion 52a. At this time, the mixture layer inclined portion 58 can be formed by gradually changing the supply amount of the coating agent by valve adjustment. The mixture layer inclined portion 58 can also be formed by scraping the end of the mixture layer 54.

Then, after the lead 60, which is a wire for taking out the outside, is welded to the core material 52, the protective tape 56 is attached.

### Advantages of Embodiment

According to the present embodiment, in the non-aqueous electrolyte secondary battery, since there is no step at the end of the mixture layer 54 containing the positive electrode active material or the negative electrode active material and the end of the protective tape 56, stress concentration at the step portion due to expansion and contraction of the electrode 50 due to a charge-discharge cycle is eliminated, damage to the electrode plate and the separator, and cracks can be prevented, and a battery having high safety can be provided.

In addition, the exposed portion 52a to which the mixture for welding the lead 60 is not applied does not contribute to a battery capacity, and when an area of the exposed portion 52a is large, the risk of foreign substance short circuit is large. Therefore, although it is desired to reduce the area of the exposed portion 52a as much as possible, the smaller the area, the higher the risk of stress concentration on the end of the mixture layer 54 and the end of the protective tape 56. According to the present embodiment, concentration of stress on the end of the mixture layer 54 and the end of the protective tape 56 can be suppressed, and thus the area of the exposed portion 52a can be reduced. As a result, an effect of further increasing the capacity of the battery and reducing the short-circuit risk can be obtained.

### “Mixture Layer”

The positive electrode includes a belt-shaped positive electrode core and a positive mixture layer formed on at least one surface of the core. As the positive electrode core, a foil of a metal, such as aluminum or an aluminum alloy, which is stable in a potential range of the positive electrode, a film in which the metal is disposed on a surface layer, or the like can be used. The positive electrode mixture layer contains a positive electrode active material, a conductive agent such as acetylene black, and a binding agent such as polyvinylidene fluoride, and may be formed on both surfaces of the positive electrode core. As the positive electrode active material, for example, a lithium transition metal composite oxide is used. The positive electrode lead 12 is connected to the positive electrode, but may be directly joined to the positive electrode core by welding or the like.

The negative electrode includes a belt-shaped negative electrode core and a negative mixture layer formed on at least one surface of the core. As the negative electrode core, a foil of a metal, such as copper or a copper alloy, which is stable in a potential range of the negative electrode, a film in which the metal is disposed on a surface layer, or the like can be used. The negative electrode mixture layer contains a negative electrode active material and a binding agent such as styrene-butadiene rubber (SBR), and may be formed on both surfaces of the negative electrode core. As the negative electrode active material, for example, graphite, a silicon-containing compound, or the like is used. A tongue-shaped negative electrode lead may be directly joined to the negative electrode core by welding or the like to be joined to the current collector plate.

### “Electrolyte”

The non-aqueous electrolyte housed in the exterior can 20 contains a non-aqueous solvent and an electrolyte salt dissolved in the non-aqueous solvent. As the non-aqueous solvent, for example, esters, ethers, nitriles, amides, and mixed solvents of two or more thereof are used. The non-aqueous solvent may contain a halogen-substituted product in which at least a part of hydrogen in a solvent described above is substituted with a halogen atom such as fluorine. Examples of the non-aqueous solvent include ethylene carbonate (EC), ethyl methyl carbonate (EMC), dimethyl carbonate (DMC), and mixed solvents thereof. As the electrolyte salt, for example, a lithium salt such as LiPF₆ is used.

### “Exterior Can”

The exterior can 20 is a bottomed cylindrical metal container having an opening at one end (upper end) in an axial direction, and has a cylinder formed in a cylindrical shape and a bottom having a circular shape in a bottom view. The exterior can 20 is generally made of metal containing iron as a main component, but may be made of metal containing aluminum or the like as a main component particularly when the exterior can 20 is electrically connected to the positive electrode. The exterior can 20 has a groove portion 22 formed along the circumferential direction of the cylinder. The groove portion 22 is formed at a position away from an opening edge (an upper end of exterior can 20) by a predetermined length near the opening of exterior can 20. The predetermined length is, for example, a length greater than or equal to 1% and less than or equal to 20% of an axial length of the exterior can 20.

In the present embodiment, a circular step 23 is provided at the bottom of the exterior can 20, and functions as a safety valve that operates when an abnormality occurs in the battery 1.

### “Protective Tape”

The protective tape 56 includes, for example, a base material layer made of an insulating organic material and an adhesive layer having adhesiveness. The insulating tape may have a layer structure of three or more layers, and the base material layer may be composed of two or more layers of the same type or different type laminated films. A thickness of the insulating tape is greater than or equal to 10 μm and less than or equal to 60 μm, for example. Examples of the resin constituting the base material layer include polyesters such as polyethylene terephthalate (PET), polypropylene (PP), polyimide (PI), polyphenylene sulfide (PPS), polyetherimide (PEI), and polyamide. Examples of the adhesive constituting the adhesive layer include an acrylic adhesive and a synthetic rubber adhesive.

### REFERENCE SIGNS LIST

1 Battery
10 Electrode assembly
12 Positive electrode lead
14 Hollow portion
20 Exterior can
21 Negative electrode terminal
22 Groove portion
23 Step
24 Upper insulating plate
25 Negative electrode current collector plate
26 Joint
30 Sealing assembly
31 Insulating ring
32 Cap
34 Current collector plate
35 Upper current collector plate
36 Gasket
50 Electrode
52 Core material
54 Mixture layer
56 Protective tape
58 Mixture layer inclined portion
60 Lead

The invention claimed is:

1. An electrode for a secondary battery comprising:
a belt-shaped core material;
a mixture layer formed on a surface of the core material; and
a lead that is bonded to an exposed portion of the surface of the core material, the exposed portion being exposed without the mixture layer being formed, and extends from one end side in a width direction of the core material,
wherein a mixture layer inclined portion inclined so that a thickness of the mixture layer around the exposed portion is reduced toward the exposed portion is provided, and a bonding margin of a protective tape covering the exposed portion falls within a range of the mixture layer inclined portion.

2. The electrode of a secondary battery according to claim 1, wherein a height of the protective tape attached onto the mixture layer inclined portion from the core material is equal to or less than a height of a non-inclined portion outside the mixture layer inclined portion from the core material.
